(19) United States
(12) Patent Application Publication
(10) Pub. No.: US 2014/0320568 A1
(43) Pub. Date: Oct. 30, 2014

(54) INKJET PRINT HEAD

(71) Applicant: SAMSUNG ELECTRO-MECHANICS CO., LTD., Suwon (KR)

(72) Inventors: Tae Kyung LEE, Suwon (KR); Byung Hun KIM, Suwon (KR); Hwa Sun LEE, Suwon (KR)

(21) Appl. No.: 13/930,480

(22) Filed: Jun. 28, 2013

(30) Foreign Application Priority Data
Apr. 25, 2013 (KR) 10-2013-0045853

(51) Int. Cl. B41J 2/14

(52) U.S. Cl. CPC B41J 2/14233
USPC 347/68

(57) ABSTRACT

There is provided an inkjet print head including a substrate member including an ink channel, a piezoelectric actuator formed on the substrate member, and a coating member formed on the piezoelectric actuator and including a photosensitive material.

### CROSS-REFERENCE TO RELATED APPLICATIONS

This application claims the priority of Korean Patent Application No. 10-2013-0045853 filed on Apr. 25, 2013, in the Korean Intellectual Property Office, the disclosure of which is incorporated herein by reference.

### BACKGROUND OF THE INVENTION

1. Field of the Invention

The present invention relates to an inkjet print head, and more particularly, to an inkjet print head able to be easily manufactured, based on a wafer, and improve driving reliability in a piezoelectric actuator.

2. Description of the Related Art

An inkjet print head is an apparatus which converts an electric signal into a physical force to discharge droplets of stored ink.

The inkjet print head may be mass-produced, and has thus been used in commercial and industrial printers. For example, the inkjet print head has been used in an office environment in which printouts are printed by discharging ink onto paper and in manufacturing facilities in which circuit patterns are directly formed by discharging a liquid-phase metal onto a printed circuit board (PCB).

Meanwhile, piezoelectric actuators mounted in the inkjet print head are connected to each other by a main board and a flexible printed circuit board (FPCB) of a printer and are actuated depending on an electrical signal transmitted from the main board.

However, industrial ink used in the inkjet print head generally includes strongly acidic or alkaline solvents, which may cause an electrode of the piezoelectric element or the piezoelectric element to be corroded.

In order to solve this defect, a technology of forming an adhesive layer having a considerable thickness on a surface of the piezoelectric element has been introduced. However, the technology according to the related art is disadvantageous in that a thickness of the inkjet print head may be increased due to the adhesive layer. Further, according to the related art, the adhesive layer considerably changes driving characteristics of the piezoelectric element, such that it may be difficult to ensure the reliability of discharge characteristics according to the driving of the piezoelectric element.

Therefore, development of the inkjet print head capable of securing driving reliability in the piezoelectric element while preventing corrosion of the piezoelectric element is requested.

Meanwhile, as related art relating to the present invention, there is provided Patent Document 1. Patent Document 1 has introduced a film 60, having a side of the piezoelectric material inclined so as to relieve a disconnection phenomenon of an electrode 70 formed on a piezoelectric material 30. However, Patent Document 1 does not disclose a configuration for preventing the piezoelectric element from being corroded.

[Related Art Document]

(Patent Document 1) KR2001-028359 A

### SUMMARY OF THE INVENTION

An aspect of the present invention provides an inkjet print head capable of securing driving reliability in a piezoelectric element while having a reduced thickness thereof.

According to an aspect of the present invention, there is provided an inkjet print head, including: a substrate member including an ink channel; a piezoelectric actuator formed on the substrate member; and a coating member formed on the piezoelectric actuator and including a photosensitive material.

The coating member may include a siloxane.

The coating member may include silicon in an amount of 50 wt % or more.

The coating member may be a dry film including silicon.

A Young's modulus of the coating member may range from 0.10 to 0.25 GPa.

A Poisson's ratio of the coating member may range from 0.2 to 0.4.

The coating member may have a thickness ranging from 50 to 200 μm.

According to another aspect of the present invention, there is provided an inkjet print head, including: a substrate member including an ink channel; a piezoelectric actuator formed on the substrate member; and a driving circuit board disposed on the substrate member and having a driving element for driving the piezoelectric actuator, mounted thereon; and a coating member formed between the substrate member and the driving circuit board, coating an upper surface of the piezoelectric actuator and bonding the substrate member to the driving circuit board, and including a photosensitive material.

The piezoelectric actuator and the driving element may be connected by a wire bonding part.

The coating member may include a siloxane.

The coating member may include silicon in an amount of 50 wt % or more.

The coating member may be a dry film including silicon.

A Young's modulus of the coating member may range from 0.10 to 0.25 GPa.

A Poisson's ratio of the coating member may range from 0.2 to 0.4.

The coating member may have a thickness ranging from 50 to 200 μm.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view of an inkjet print head according to an embodiment of the present invention;

FIG. 2 is a cross-sectional view of another form of the inkjet print head illustrated in FIG. 1;

FIG. 3 is a flow chart illustrating a process of manufacturing the inkjet print head illustrated in FIG. 1;

FIG. 4 is a cross-sectional view of an inkjet print head according to another embodiment of the present invention; and

FIG. 5 is a cross-sectional view of another form of the inkjet print head illustrated in FIG. 4.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

An industrial inkjet printer may print ink including strongly acidic or alkaline solvents onto a substrate or an LCD panel. In this case, the solvent included in the ink may be evaporated by heat generated from the printer and form solvent vapor.

However, the solvent vapor may corrode an electrical pattern of an inkjet print head configuring the inkjet printer (for example, an electrode of a piezoelectric actuator or a flexible substrate (a film type substrate) connecting the piezoelectric actuator to a printer substrate).

The corrosion of the electrode of the piezoelectric actuator or the film type substrate may hinder signals from being accurately transferred to the piezoelectric actuator, thereby hindering the precision printing work of the inkjet printer and high resolution outputs.

In order to solve the defects outlined above, a passivation layer may be formed on the piezoelectric actuator. In general, the passivation layer has a thickness of several mm. However, as the piezoelectric actuator is thinned to have a thickness of several μm, the performance of the piezoelectric actuator due to the passivation layer may be degraded. In fact, the maximum displacement of the piezoelectric actuator without a passivation layer ranges from 100 to 120 nm, but the displacement of the piezoelectric actuator provided with the passivation layer having a thickness of several mm is 50 nm or less.

A need exists for a new technology, capable of ensuring the displacement of the piezoelectric actuator while protecting the piezoelectric actuator from the solvent vapor.

The embodiment of the present invention, developed in consideration of this aspect, may provide an inkjet print head capable of protecting the piezoelectric actuator from the solvent and ensuring the displacement of the piezoelectric actuator.

To this end, in the embodiment of the present invention, a coating member may be formed on the piezoelectric actuator.

Here, the thickness of the coating member may be several tens to hundreds of μm. In other words, the thickness of the coating member may be 50 to 200 μm. Preferably, the thickness of the coating member may be 50 to 100 μm, more preferably, 50 μm.

Further, the coating member may include a silicon compound or a siloxane. In other words, the coating member may include the silicon compound or the siloxane in an amount of 10 wt % or more. Preferably, the coating member may include the silicon compound or the siloxane in an amount 10 to 70 wt %, more preferably, 50 wt %. For reference, ingredients corresponding to the remaining wt % may vary depending on a type of the coating member. For example, when the coating member is a photocurable dry film, the ingredients corresponding to the remaining wt % may include general ingredients of the dry film. However, according to the embodiment of the present invention, a material of the coating member is not limited to including the silicon compound or the siloxane. For example, the coating member may be formed of other materials having the Young's modulus ranging from 0.10 to 0.25 GPa. For example, the coating member may be formed of one of low density polyethylene (LDPE), high density polyethylene (HDPE), and polytetrafluoroethylene (PTFE) or a compound including at least one thereof.

In addition, the coating member may be formed of a material having the Poisson's ratio of 0.2 to 0.4. Preferably, the coating member may be formed of a material selected from materials of which the Young's modulus and the Poisson's ratio satisfy all the above-mentioned conditions.

Here, the coating member satisfying the conditions may be a dry film, used in a process of manufacturing the inkjet print head. Preferably, the coating member may be a photocurable dry film.

Meanwhile, in the inkjet print head according to the embodiment of the present invention, displacement characteristics of the piezoelectric actuator are as presented in the following Table 1. For reference, the piezoelectric actuator used in experiments was a product having the displacement characteristics of 104.4 nm under pressure conditions of 10⁵ Pa.

TABLE 1

| | | | Experi- | Experi- | Experi- |
|---|---|---|---|---|---|
| | | Young's | mental | mental | mental |
| | Wt % of | Modulus | Example 1 | Example 2 | Example 3 |
| Remarks | siloxane | [Gpa] | 50 μm | 100 μm | 200 μm |
| 1 | 10 | 1.4 | 43.00 | 42.60 | 42.60 |
| 2 | 50 | 0.24 | 83.60 | 83.00 | 83.60 |
| 3 | 70 | 0.15 | 90.40 | 90.20 | 90.40 |

In the Table 1, Experimental Examples 1 to 3 indicate cases in which thicknesses of coating members are different. In other words, Experimental Example 1 indicates a case in which the thickness of the coating member is 50 μm, Experimental Example 2 indicates a case in which the thickness of the coating member is 100 μm, and Experimental Example 3 indicates a case in which the thickness of the coating member is 200 μm. Unlike this, Remarks 1 to 3 indicate cases in which the thicknesses of the coating members are the same but different weight percents of the siloxane are included. In other words, Remark 1 indicates a case in which 10 wt % of the siloxane is included in the coating member, Remark 2 indicates a case in which 50 wt % of the siloxane is included in the coating member, and Remark 3 indicates a case in which 70 wt % of the siloxane is included in the coating member.

For reference, in Table 1, values of portions in which vertical-axis items (Remarks 1 to 3) intersect with horizontal-axis items (Examples 1 to 3) refer to displacement values [unit nm] of the piezoelectric actuator. For example, a value (83.60 nm) of a portion in which Remark 2 intersects with Experimental Example 1 refers a displacement of a piezoelectric actuator provided with a coating member including 50 wt % of a siloxane and having a thickness of 50 μm.

As can be appreciated from Table 1, the displacement (83.00 to 90.40 nm) of the piezoelectric actuator in the case in which the coating member including 50 wt % or more of siloxane is formed in the piezoelectric actuator is rarely different from the displacement (104.4 nm) of the piezoelectric actuator before the coating member is formed in the piezoelectric actuator. In particular, in the case as described above, even when the thickness of the coating member increases from 50 to 200 μm, sufficient displacement of the piezoelectric actuator may be ensured.

Therefore, in order to improve the driving reliability in the piezoelectric actuator, the coating member including 50 wt % or more of the siloxane may be used. Meanwhile, the Table 1 is limited to providing the Experimental Examples of the coating member including the siloxane, but as long as the Young's modulus of the coating member, ranging from 0.15 to 0.24 is secured, the siloxane may be substituted with other compounds or the wt % of the siloxane may be adjusted.

Hereinafter, the inkjet print head including the coating member having physical characteristics as above will be described. Hereinafter, embodiments of the present invention will be described in detail with reference to the accompanying drawings.

In describing the present invention below, terms indicating components of the present invention will be named in consideration of functions of respective components. Therefore, the terms should not be understood as limiting technical components of the present invention.

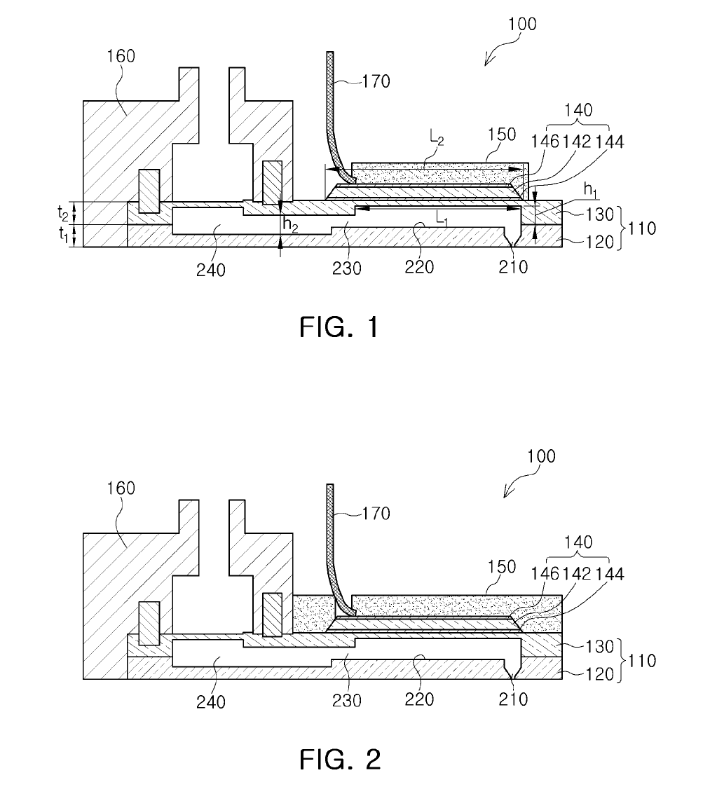

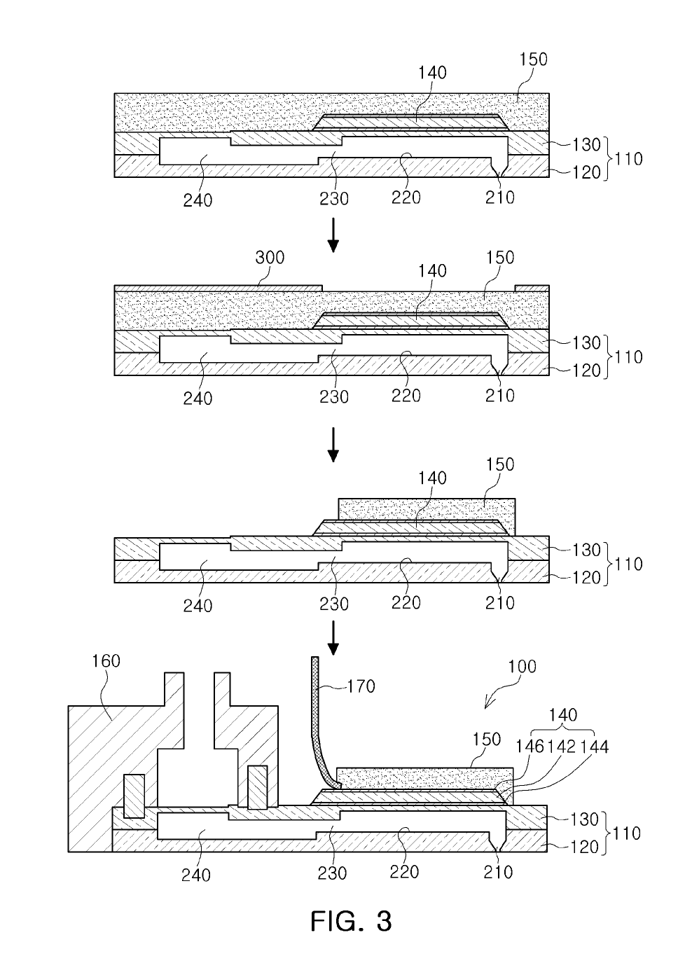

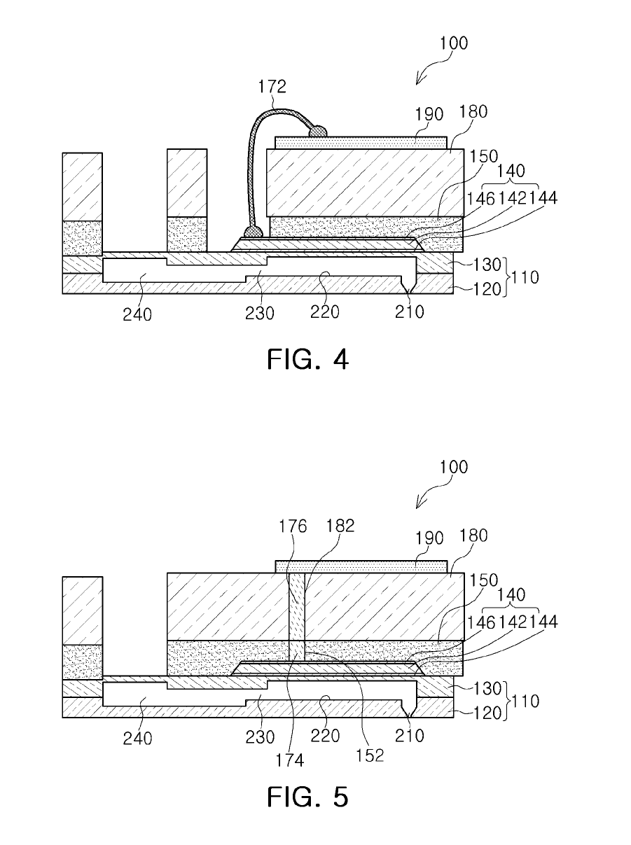

FIG. 1 is a cross-sectional view of an inkjet print head according to an embodiment of the present invention. FIG. 2 is a cross-sectional view of another form of the inkjet print head illustrated in FIG. 1. FIG. 3 is a flow chart illustrating a process of manufacturing the inkjet print head illustrated in FIG. 1. FIG. 4 is a cross-sectional view of an inkjet print head according to another embodiment of the present invention. FIG. 5 is a cross-sectional view of another form of the inkjet print head illustrated in FIG. 4.

An inkjet print head according to an embodiment of the present invention will be described with reference to FIG. 1.

An inkjet print head 100 according to an embodiment of the present invention may include a substrate member 110, a piezoelectric actuator 140, and a coating member 150.

The substrate member 110 may form an inkjet print head including a nozzle and a pressure chamber. The substrate member 110 may be configured of at least two silicon substrates. For example, the substrate member 110 may have a stacked structure of a first substrate 120 and a second substrate 130. However, the substrate member 110 may include three sheets of substrates depending on a size and a type of the inkjet print head.

The first substrate 120 may be a single crystalline silicon substrate or a silicon on insulator (SOI) substrate as needed. The first substrate 120 may include a nozzle 210 and a restrictor 230.

The nozzle 210 may be formed to vertically penetrate through the first substrate 120. Further, the nozzle 210 may have a shape of a cross-section gradually decreased downward (in a Z-axial direction in FIG. 1). The nozzle 210 having the above cross-sectional shape may discharge a predetermined amount of ink even in the case in which driving force of the piezoelectric actuator 140 is small. Therefore, the inkjet print head 100 including the nozzle 210 having the cross-sectional shape may employ the piezoelectric actuator 140 having a relatively small size and may be driven with a relatively small amount of current. However, the cross-sectional shape of the nozzle 210 is not limited to having a shape illustrated in FIG. 1, but may be a cross-sectional shape having the same size in a vertical direction as needed.

The restrictor 230 may be formed in one surface of the first substrate 120. Described in detail, the restrictor 230 may be formed in an upper surface of the first substrate 120 (based on FIG. 1) to have a predetermined depth and may be spaced apart from the nozzle 210 by a predetermined distance. The restrictor 230 may be used as a channel through which ink flows and serve to restrict a flow amount of ink.

Meanwhile, FIG. 1 illustrates that the nozzle 210 and the restrictor 230 are formed in the first substrate 120, but a part of a pressure chamber or a part of a manifold may be formed in the first substrate 120 as needed. Further, a damper or the like, capable of preventing ink from being rapidly discharged through the nozzle 210 may be additionally formed on the first substrate 120.

The second substrate 130 may be formed of a single crystalline silicon substrate or a silicon on insulator (SOI) substrate as needed. The second substrate 130 may include a pressure chamber 220 and a manifold 240. Meanwhile, the accompanying drawings illustrate that a thickness t1 of the first substrate 120 and a thickness t2 of the second substrate 130 are identical to each other, but as needed, the thickness t1 of the first substrate 120 may be increased as compared to the thickness t2 of the second substrate 130, or vice versa.

The pressure chamber 220 may be formed on a lower surface of the second substrate 130(based on FIG. 1). In other words, the pressure chamber 220 may be formed to partially face the nozzle 210 and the restrictor 230 of the first substrate 120. That is, the pressure chamber 220 may be connected to the nozzle 210 and the restrictor 230 of the first substrate 120 when the first substrate 120 and the second substrate 130 are stacked. Further, the pressure chamber 220 may have a volume identical to or greater than a single ink discharge amount.

The manifold 240 may be formed on the lower surface of the second substrate 130 (based on FIG. 1). In other words, the manifold 240 is formed to be spaced apart from the pressure chamber 220 by a predetermined distance and may be connected to the restrictor 230 of the first substrate 120 when the first substrate 120 and the second substrate 130 are stacked. Further, a depth h2 at which the manifold 240 is formed in the second substrate 130 (hereinafter, referred to as the depth h2 of the manifold 240) may be identical to a depth h1 at which the pressure chamber 220 is formed (hereinafter, referred to as the depth h1 of the pressure chamber 220). In this case, the pressure chamber 220 and the manifold 240 may be easily formed in the second substrate 130. That is, when the depths of the pressure chamber 220 and the manifold 240 are identical to each other, the pressure chamber 220 and the manifold 240 may be simultaneously formed by a one-time etching process of the second substrate 130. However, the depths of the pressure chamber 220 and the manifold 240 may be different as needed. For example, the depth h2 of the manifold 240 may be identical to the thickness t2 of the second substrate 130. In this case, the second substrate 130 may be additionally provided with an ink inlet through which ink is supplied to the manifold 240.

The piezoelectric actuator 140 may be formed on the second substrate 130. In other words, the piezoelectric actuator 140 may be formed on an upper surface of the second substrate 130 (based on FIG. 1) and may apply a predetermined amount of pressure to the pressure chamber 220 of the second substrate 130 such that the ink stored in the pressure chamber 220 may be discharged through the nozzle 210. To this end, the piezoelectric actuator 140 may be formed in a position corresponding to the pressure chamber 220 on the second substrate 130. Further, a length L2 of the piezoelectric actuator 140 may be identical to a length L1 of the pressure chamber 220.

The piezoelectric actuator 140 may include a piezoelectric element 142, a first electrode 144, and a second electrode 146.

The piezoelectric element 142 may be formed of a piezoelectric material. For example, the piezoelectric element 142 may be formed of ceramics, in more detail, the piezoelectric element 142 may be formed of lead zirconate titanate (PZT). The piezoelectric element 142 formed of such a material may be contracted or relaxed depending on an external electric signal and may apply pressure to the pressure chamber 220 of the second substrate 130. The size of the piezoelectric element 142 may be in proportion to the length L1 of the pressure chamber 220 and may be the same as the length L1 of the pressure chamber 220.

The first electrode 144 may be formed on the second substrate 130. In other words, the first electrode 144 may be formed on the second substrate 130 via an adhesive, such as epoxy, and may be formed to have the same size as the piezoelectric element 142. The first electrode 144 may be formed of a conductive material and may provide a first polarity current of the piezoelectric element 142. To this end, the first electrode 144 may be electrically connected to an external power supply or an external circuit board. Further, the first electrode may include two thin metal layers formed of titanium (Ti) and platinum (Pt), respectively. The first electrode 144 may serve as a common electrode.

The second electrode 146 may be formed on the piezoelectric element 142. The second electrode 146 may be formed of one of Pt, Au, Ag, Ni, Ti, Cu, or the like, and may provide current having a different polarity from the first electrode 144 to the piezoelectric element 142. For reference, in the embodiment of the present invention, the second electrode 146 is connected to a flexible substrate 170.

Meanwhile, the embodiment of the present invention illustrates the case in which the first electrode 144 is formed on a lower surface of the piezoelectric element 142 and the second electrode 146 is formed on an upper surface of the piezoelectric element 142, but in some cases, the positions of the first electrode 144 and the second electrode 146 may be changed.

As illustrated in FIG. 1, the coating member 150 may be formed on the piezoelectric actuator 140. In other words, the coating member 150 may be formed on the piezoelectric actuator 140 to relieve a phenomenon in which an upper portion of the piezoelectric actuator corrodes. Meanwhile, as illustrated in FIG. 2, the coating member 150 may be formed on both upper portions of the piezoelectric actuator 140 and the second substrate 130 as needed. In this case, a phenomenon in which the upper portion of the second substrate 130 corrodes due to a solvent may be relieved.

As described above, the coating member 150 may be a member including a siloxane. In other words, the coating member 150 may be a member including 50 wt % or more of the siloxane. Further, the coating member 150 may be selected from members having the Poisson's ratio of 0.3. Further, the coating member 150 may be selected from members having the Young's Modulus ranging from 0.15 to 0.24 GPa. Preferably, the coating member 150 may be selected from members having the Poisson's ratio of 0.3 and the Young's Modulus ranging from 0.15 to 0.24 GPa. For example, the coating member 150 may be formed of one of low density polyethylene (LDPE), high density polyethylene (HDPE), and polytetrafluoroethylene (PTFE) or a compound including at least one thereof.

The coating member 150 may be a dry film. In other words, the coating member 150 may be a curable dry film. For example, the coating member 150 may include both of a positive dry film and a negative dry film.

A bezel 160 may be formed on the second substrate 130. In other words, the bezel 160 may be connected to the manifold 240 of the second substrate 130 and may have a space in which a considerable amount of ink is stored. For reference, the bezel 160 illustrated in FIG. 1 may be omitted depending on a structure of the inkjet print head 100.

The inkjet print head 100 having the foregoing structure as described above may prevent malfunctions due to corrosion of the piezoelectric actuator 140 or leakage of ink due to the corrosion of the second substrate 130 since the upper portions of the piezoelectric actuator 140 and the second substrate 130 are protected by the coating member 150.

Further, in the inkjet print head 100 according to the embodiment of the present invention, the displacement characteristics of the piezoelectric actuator 140 may be sufficiently secured even in a state in which the coating member 150 is formed (refer to Table 1 and the contents in connection with Table 1) is formed, thereby improving the discharge performance of the inkjet print head 100. Therefore, the inkjet print head 100 according to the embodiment of the present invention may be widely used in manufacturing processes of various electronic devices requiring high-quality printing characteristics.

Meanwhile, the inkjet print head 100 according to the embodiment of the present invention may be manufactured according to the order illustrated in FIG. 3. In other words, the process of manufacturing an inkjet print head 100 may include a process of forming a coating member, a process of forming a development mask, and a process of removing the coating member. In addition, the process of manufacturing the inkjet print head 100 may further include a process of forming a bezel and a circuit connection process.

1) Process of Forming Coating Member

In the process of forming a coating member, the coating member 150 may be formed on the substrate member 110. The coating member 150 may be formed over the entire region of the upper portion of the second substrate 130. The coating member 150 may be formed by methods, such as thin film evaporation, printing, and the like. Here, the coating member 150 may be formed of a photocurable material. For example, the coating member 150 may be a dry film.

2) Process of Forming Development Mask

In the process of forming a development mask, a mask 300 may be formed on a region of the coating member 150 from which the coating member 150 is removed. Here, the mask 300 may be formed of a light blocking material. However, when the coating member 150 is a negative dry film, the mask 300 is formed on a region on which the coating member 150 will remain and may be formed of a light transmissive material. For reference, the method of forming the mask 300 may be selected from among methods of forming a photo mask commonly known in the art.

Further, in the process of forming a development mask, the coating member 150 may be cured. Here, the curing of the coating member 150 may be performed only in a portion thereof outwardly exposed from the mask 300. Therefore, a portion covered by the mask 300 may be easily removed by etching and the portion outwardly exposed from the mask 300 may not be easily removed by etching.

3) Process of Removing Coating Member

In the process of removing the coating member, the mask 300 and a non-cured region of the coating member 150 may be removed. The removal of the mask 300 and the coating member 150 may be performed by a method, such as dry etching, wet etching, or the like.

4) Other Processes

When the foregoing processes are completed, a process of connecting the piezoelectric actuator 140 to the external power supply and a process of forming the bezel may be additionally performed. For reference, these processes may be omitted or performed in a previous process as needed.

Next, an inkjet print head according to another embodiment of the present invention will be described with reference to FIGS. 3 and 6.

The inkjet print head 100 according to the embodiment of the present invention may further include a driving circuit board 180. In other words, the inkjet print head 100 according to the embodiment of the present invention may further include the driving circuit board 180 on which a driving element 190 transmitting a driving signal of the piezoelectric actuator 140 is mounted.

Further, in the inkjet print head 100 according to the embodiment of the present invention, the coating member 150 is formed in the greater part of the second substrate 130 and may be used as an adhesive layer connecting the second substrate 130 to the driving circuit board 180.

The driving element 190 of the driving circuit board 180 and the piezoelectric actuator 140 may be connected by a wire bonding part 172 (see FIG. 4) or via electrodes 174 and 176 (see FIG. 5).

In the inkjet print head 100 having the foregoing structure, a space required for mounting the driving circuit and the driving element 190 therein may be reduced and the size of the inkjet print head 100 may be reduced accordingly.

As set forth above, according to the embodiments of the present invention, the corrosion or oxidation of an electrode of an inkjet print head due to a solvent gas included in ink can be prevented.

Therefore, according to the embodiments of the present invention, driving characteristics of a piezoelectric actuator can be uniformly maintained to increase output resolution of the inkjet print head.

Further, according to the embodiments of the present invention, a thickness of the inkjet print head can be reduced and driving reliability in a piezoelectric element can be secured.

While the present invention has been shown and described in connection with the embodiments, it will be apparent to those skilled in the art that modifications and variations can be made without departing from the spirit and scope of the invention as defined by the appended claims.

What is claimed is:

1. An inkjet print head, comprising:
a substrate member including an ink channel;
a piezoelectric actuator formed on the substrate member; and
a coating member formed on the piezoelectric actuator and including a photosensitive material.

2. The inkjet print head of claim 1, wherein the coating member includes a siloxane.

3. The inkjet print head of claim 1, wherein the coating member includes silicon in an amount of 50 wt % or more.

4. The inkjet print head of claim 1, wherein the coating member is a dry film including silicon.

5. The inkjet print head of claim 1, wherein a Young's modulus of the coating member ranges from 0.10 to 0.25 GPa.

6. The inkjet print head of claim 1, wherein a Poisson's ratio of the coating member ranges from 0.2 to 0.4.

7. The inkjet print head of claim 1, wherein the coating member has a thickness ranging from 50 to 200 μm.

8. An inkjet print head, comprising:
a substrate member including an ink channel;
a piezoelectric actuator formed on the substrate member; and
a driving circuit board disposed on the substrate member and having a driving element for driving the piezoelectric actuator, mounted thereon; and
a coating member formed between the substrate member and the driving circuit board, coating an upper surface of the piezoelectric actuator and bonding the substrate member to the driving circuit board, and including a photosensitive material.

9. The inkjet print head of claim 8, wherein the piezoelectric actuator and the driving element are connected by a wire bonding part.

10. The inkjet print head of claim 8, wherein the coating member includes a siloxane.

11. The inkjet print head of claim 8, wherein the coating member includes silicon in an amount of 50 wt % or more.

12. The inkjet print head of claim 8, wherein the coating member is a dry film including silicon.

13. The inkjet print head of claim 8, wherein a Young's modulus of the coating member ranges from 0.10 to 0.25 GPa.

14. The inkjet print head of claim 8, wherein a Poisson's ratio of the coating member ranges from 0.2 to 0.4.

15. The inkjet print head of claim 8, wherein the coating member has a thickness ranging from 50 to 200 μm.
